(19) United States
(12) Patent Application Publication
(10) Pub. No.: US 2006/0115692 A1
(43) Pub. Date: Jun. 1, 2006

(54) Method for intelligently arranging a fuel cell system with controllable dynamic series and parallel connections and the fuel cell system itself

(75) Inventor: Feng-Yi Deng, Taipei (TW)

Correspondence Address: G .LINK Co.,LTD, Suite 137 ,PmB 174, 931 West, 75th Street, NAPERVILLE, IL, 60565, US

(73) Assignee: ANTIG TECHNOLOGY Co , Ltd.

(21) Appl. No.: 10/996,859

(22) Filed: Nov. 26, 2004

(51) Int. Cl. H01M 8/00; H01M 8/04

(52) U.S. Cl. 429/13; 429/22

(57) ABSTRACT

A method for arranging fuel cell system with intelligently controllable dynamic series and parallel connections, including the following steps: The first step is to provide at least one multi-route switch. The second step is to electrically connect at least two fuel cells to the multi-route switch. The third step is to control the multi-route switch to allow the two or more fuel cells connecting with the multi-route switch to be arranged as one of the following connection modes: series connection, parallel connection, open circuit and partly close circuit.

### FIELD OF THE INVENTION

The present invention is related to a method for arranging fuel cell units in a fuel cell system, particularly to a method for arranging a fuel cell system using intelligent controllable dynamic series and parallel connections.

### BACKGROUND OF THE INVENTION

Generally speaking, fuel cell refers to a power generation device, with which a fuel containing hydrogen reacts with oxygen to generate electricity directly without the combustion process. Unlike the typical primary batteries, which have to be discarded after use, or the rechargeable batteries, which have to be recharged after its power is exhausted, fuel cell can generate power continuously as long as fuel is added.

Using the proton exchange membrane fuel cell (PEMFC) as an example, hydrogen is used as the fuel. During the anode reaction, hydrogen enters from the diffusion layer. And through the catalysis by the catalysts in the catalyst layer—such as platinum, hydrogen is dissolved into hydrogen proton and electron. The former enters the cathode reaction area via the proton exchange membrane, and the latter is transmitted to the outside load via a current collection device. On the opposite side, oxygen enters via the diffusion layer at the cathode end, is dissolved through the catalysis by the catalysts in the catalyst layer—such as platinum, and then is united with the hydrogen protons from the proton exchange layer and the electrons from the current collection device to produce water in the cathode reaction area. This completes the power generation reaction. The chemical reaction formulae are shown underneath:
Anode reaction: 2H₂→4H⁺+4e⁻
Cathode reaction: O₂+4H⁺+4e⁻→2H₂O
Gross reaction: 2 H₂+O₂→2 H₂O

Taking direct methanol fuel cell (DMFC) as an example, the center layer is the proton exchange membrane that conducts the proton transfer. On the two sides of the proton exchange membrane are the catalyst layers. The catalyst layers are where the anode and the cathode electrical-chemical reaction take place. The outermost layers are the diffusion layers. The anode reaction substance methanol enters via the diffusion layer and reacts in the catalyst layer, and the carbon dioxide produced during the chemical reaction is discharged via the diffusion layer of the anode side. The hydrogen protons conduct the proton transfer via the membrane-electrode assembly layer. At this time, the anode collection layer collects the currents and the electrons are returned to the cathode via the load and unite with the hydrogen proton from the proton transfer. The combined electrons and hydrogen protons then react at the catalyst layer with the oxygen entered through the diffusion layer of the cathode side. Water is produced then discharged via the diffusion layer of the cathode end, thereby completing the power generation reaction. The chemical reaction formulas are shown underneath:
Anode reaction: CH₃OH+H₂O→CO₂+6H⁺+6e⁻
Cathode reaction: 3/2O₂+6H⁺+6e⁻→3 H₂O
Gross reaction: CH₃OH+3/2O₂→CO₂+2H₂O

A fuel cell unit usually includes a proton exchange membrane in the center, two catalyst layers on the two opposite sides of the proton exchange membrane, and two gas diffusion layers on the outside. The above listed reactions are the most fundamental principles of a fuel cell operation. For a proton exchange membrane fuel cell (PEMFC), the ideal potential generated by a fuel cell unit is 1.2V. For a direct methanol fuel cell (DMFC) system, the ideal potential generated by a fuel cell unit is 1.2V. Analyzing the operation of PEMFC, one can gather that there are at least four sources of power loss: anode activation loss, cell impedance loss, cathode activation loss and proton transfer loss. Compared to operation of PEMFC, DMFC has similar sources of power losses except for the addition of the potential loss from methanol crossover. These power losses cause the ideal potential to drop by different degrees, resulting in poor power generation efficiency of the fuel cell unit. These potential drops cause the voltage of a single fuel cell unit to decrease by 0.4-0.8V, or even more, making the power output rate of the fuel cell unstable.

In addition to the above listed situations, ambient environment factors during operation of the fuel cell also influence power generation efficiency of the fuel cell. Different operation temperatures, operation pressure and flow rates of oxygen supply all affects power generation efficiencies. Besides, for DMFC system, concentration ratio and crossover of methanol are also important factors influencing the power generation efficiency. These factors and combinations of these factors cause both the potential drop and the current density of the fuel cell system to fluctuate over a wide range, such that the voltage and current output of the fuel cell system become pretty unstable, further resulting in unstable power output of the fuel cell.

Also, currently fuel cells can be divided into the following types: stack type fuel cells, planar type fuel cells, and hybrid type fuel cells. The stack type fuel cells refer to each of the cells stacked on top of one another. Each additional stack increases the thickness of the system. The planar type fuel cells refer to each of the cells being assembled along side one another horizontally, extending into a large flat panel. The hybrid type fuel cells combine assembly methods of both types. Regardless of the type of the fuel cell, the cell units all have to be connected in series and/or parallel to provide power. Series connection increases output voltage and parallel connection increase the available current. For stack type fuel cells, the most direct method is series connection due to its stack assembly method. External connections would be required to achieve parallel connection. For planar type fuel cells, parallel connection is more convenient. Hybrid type is most complex. Regardless of the type, once the connection of the fuel cells is fixed, it typically is impossible to change its series or parallel connections any more.

FIG. 1 illustrates how the conventional fuel cells are assembled. Each fuel cell unit in FIG. 1 may experience unstable power output. As the operational efficiency of the fuel cell system is concerned, if the power output of the fuel cell units were inconsistent, the system's life span usually will be reduced. The larger the discrepancy in power output, the faster the life span shortens. FIG. 1 shows a total of six fuel cell units. Assume each fuel cell unit provides the standard voltage of 0.6V, and two sets of three fuel cell units are formed. Each three fuel cell units are connected in series and the two sets are then connected in parallel. Then in the case that fuel cell unit 10A experiences unstable power output, such as the voltage drops to 0.2V, the efficiency of the fuel cell system 10 would rapidly decline due to the influence of that fuel cell unit 10A, and the power output of the entire fuel cell system 10 would decline rapidly as well. More so, if any of the cell units fails or is damaged, the entire fuel cell system 10 would lose its functionality completely. And because the fuel cell units within the fuel cell systems 10 is assembled using the conventional method of fixed connections, it is not possible to let the damaged cell unit 10A to be open circuit and the entire fuel cells 10 would have to be discarded.

Further, despite the fact that fuel cell system 10 contains six fuel cell units, due to the fact that the connections within fuel cell system 10 is fixed, it is not possible to change the fuel cell units to change to their voltage.

### SUMMARY OF THE INVENTION

The first object of the present invention is to provide a method for intelligently arranging a fuel cell system with controllable dynamic series and parallel connections, and a fuel cell system implementing such method so that each fuel cell unit in the fuel cell system can be dynamically connected to provide different voltages and currents.

The second object of the present invention is to provide an arrangement method for disposing a fuel cell system with intelligent controllable dynamic series and parallel connections, and a fuel cell system implementing such a method that each individual defect fuel cell unit can be isolated as an individual open circuit so that rest of the fuel cell units can still function and the fuel cell system used more effectively.

In order to achieve the preceding objects, the present invention provides a method for arranging a fuel cell system with intelligent controllable dynamic series and parallel connections, including the following steps: providing at least one multi-route switch; two or more fuel cells electrically connected to the multi-route switch; and controlling the multi-route switch so that the two or more fuel cell units connected to the multi-route switch can be arranged in series connection, parallel connection, open circuit, or partly close circuit.

Further, in order to achieve the preceding objects, the present invention provides a fuel cell system with intelligent controllable dynamic series and parallel connections, including the following characteristics: at least one multi-route switch; two or more fuel cells electrically connected to the multi-route switch; a microcontroller to monitor the power output of the fuel cell system and to control the switching of the multi-route switch so that the two or more fuel cell units connected to the multi-route switch can be arranged in series connection, parallel connection, open circuit, and/or partly close circuit.

### BRIEF DESCRIPTION OF THE DRAWINGS

The detail structure, the applied principle, the function and the effectiveness of the present invention can be more fully understood with reference to the following description and accompanying drawings, in which:

FIG. 1 is plan view of illustrating a fixed assembly method the conventional fuel cells;

FIG. 2 is a flow chart of a method for arranging a fuel cell system with intelligent controllable dynamic series and parallel connection according to the present invention;

FIG. 3 is a plan view illustrating the structure of fuel cell system according to the present invention;

FIG. 4 is a plan view illustrating a multi-route switch according to the present invention;

FIG. 5 is a table illustrating the multi-route switch corresponding to electrical connecting types;

FIG. 6A is a plan view illustrating the multi-route switch being switched to electrical connection in series;

FIG. 6B is a plan view illustrating the multi-route switch being switched to electrical connection in parallel;

FIG. 6C is a plan view illustrating the multi-route switch being switched to electrical connection in open circuit;

FIG. 6D is a plan view illustrating the multi-route switch being switched to electrical connection in partly close circuit;

FIG. 6E is a plan view illustrating the multi-route switch being switched to another electrical connection in partly close circuit;

FIG. 7 is a block diagram illustrating an embodiment of the present invention; and

FIG. 8 is a table illustrating the multi-route switch corresponding to electrical connection types.

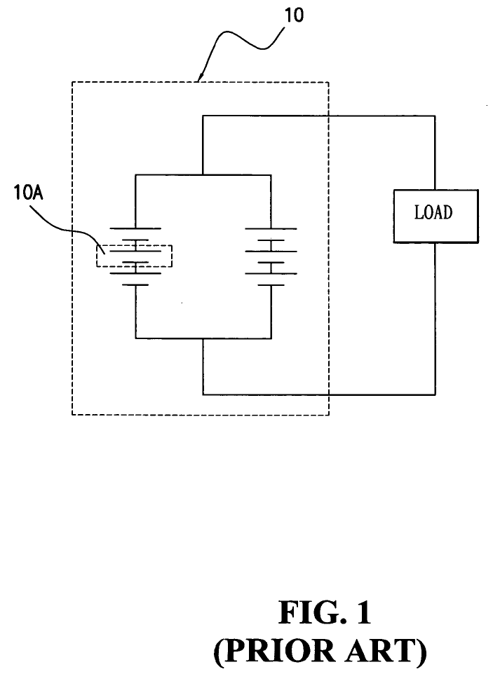

### DETAILED DESCRIPTION OF THE INVENTION

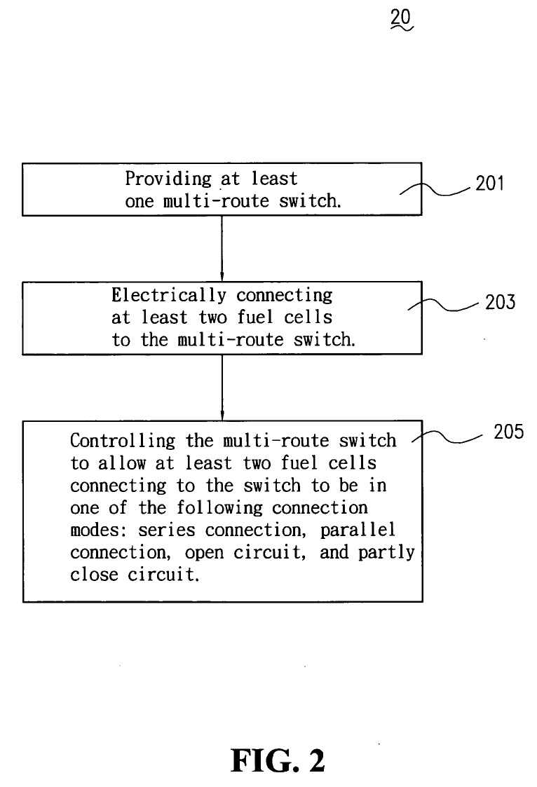

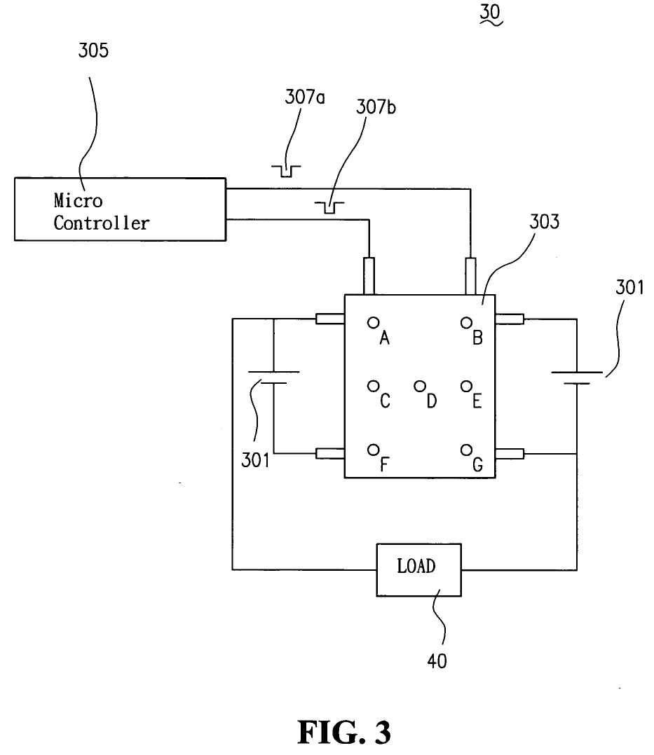

Referring to FIGS. 2 and 3, a method 20 for intelligently arranging a fuel cell system with controllable dynamic series and parallel connections according to the present invention is mainly applied to the field of fuel cell system. The fuel cell system 30 implemented with the method 20 of the present invention can control all the fuel cells 301 in the system to allow all the fuel cells 301 to be connected in parallel, or in series, or to be completely disconnected to the load 40, or in such way that only those fuel cells 301 in good condition are connected with the load 40, while the defect cells are disconnected from the circuit, depending on the requirement of load 40 and the status of fuel cells 301.

The steps of method 20 according to the present invention are described in detail hereinafter. Step 201 is related to providing one or more multi-route switch 303, which may be an electronic multi-route switch such as a switch constituted with Metal-Oxide Field Effect Transistor (MOSFET). Step 203 electrically connected two or more fuel cell 301 to the multi-route switch 303. Each of the fuel cells 301 has positive pole and negative pole electrically connected to the multi-route switch 303, and the multi-route switch 303 has two output pins 303c, 303d connected to the load 40. Step 205 is to control connection modes 50 of the multi-route switch 303 to allow the two or more fuel cells 301 connected to multi-route switch 303 to be electrically connected in series circuit, parallel circuit, open circuit or partly close circuit. The multi-route switch 303 has control signal input pins 303a, 303b to receive control signals 307a, 307b, and switch to different electrical connection modes according to the received control signals 307a, 307b.

Referring to FIG. 3, the fuel cell system 30 includes a multi-route switch 303, two or more fuel cells 301, and a micro controller 305. At least two fuel cells 301 are electrically connected to the multi-route switch 303 and the micro controller 305 is used for controlling connection modes 50 of the multi-route switch 303. Hence, the two or more fuel cells 301 connected to multi-route switch 303 can be arranged in series circuit, parallel circuit, open circuit or partly close circuit connections.

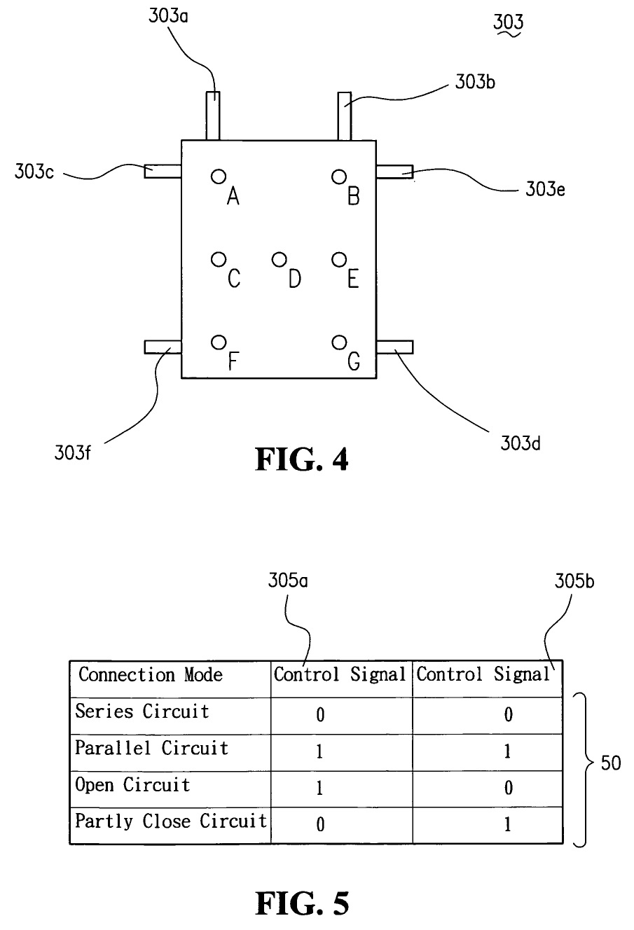

Referring to FIG. 4, the multi-route switch 303 has the control signal input pins 303a and 303b connected to the micro controller 305 to receive control signals 307a, 307b. Two output pins 303c, 303d are connected to positive pole and negative pole of the load 40. The positive pole and negative pole of each fuel cell 301 are connected to pins 303e, 303f and output pins 303c, 303d of the multi-route switch 303. Inner ends A, B, C, D, E, E, F and G of the multi-route switch 303 are controlled by control signals 307a, 307b to be either connected or disconnected with each other.

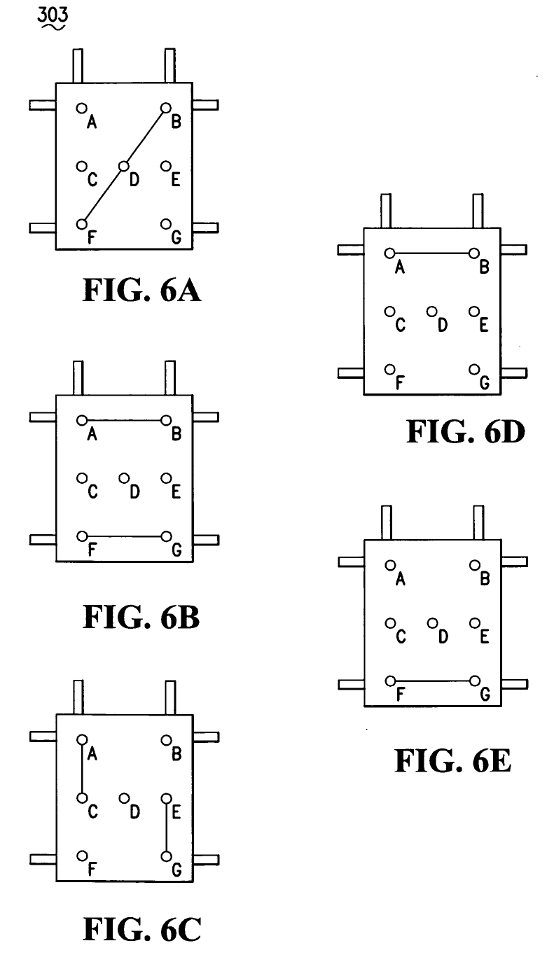

FIG. 5 illustrates the different electrical connections corresponding to the different switches of the multi-route switch. When the micro controller 305 outputs control signals 307a and 307b of “0” (low voltage lever), the series connection is arranged and the corresponding state of the multi-route switch 303 is shown in FIG. 6A. When the micro controller 305 outputs control signals 307a and 307b of “1” (high voltage lever), the parallel connection is arranged and the corresponding state of the multi-route switch 303 is shown in FIG. 6B. When the micro controller 305 outputs control signal 307a of “1” (low voltage reference lever) and control signal 307b of “0” (high voltage reference lever), the open circuit is arranged and the corresponding state of the multi-route switch 303 is shown in FIG. 6C. When the micro controller 305 outputs control signal 307a of “0” (low voltage reference lever) and control signal 307b of “1” (high voltage reference lever), the partly close connection mode is arranged and the corresponding state of the multi-route switch 303 is shown in FIG. 6D. That is, the fuel cell 301 at the right side of FIG. 2 is in good condition and supplies power to load 40, while the fuel cell 301 at the left side of FIG. 2 is defective and has stopped to operate. Alternatively, when the micro controller 305 outputs control signal 307a of “0” (low voltage reference lever) and control signal 307b of “1” (high voltage reference lever), a partly close connection mode is arranged and the corresponding state of the multi-route switch 303 is shown in FIG. 6E. That is, the fuel cell 301 at the left side of FIG. 2 is in good condition and supplies power to load 40, while the fuel cell 301 at the right side of FIG. 2 is defect and has stopped operating.

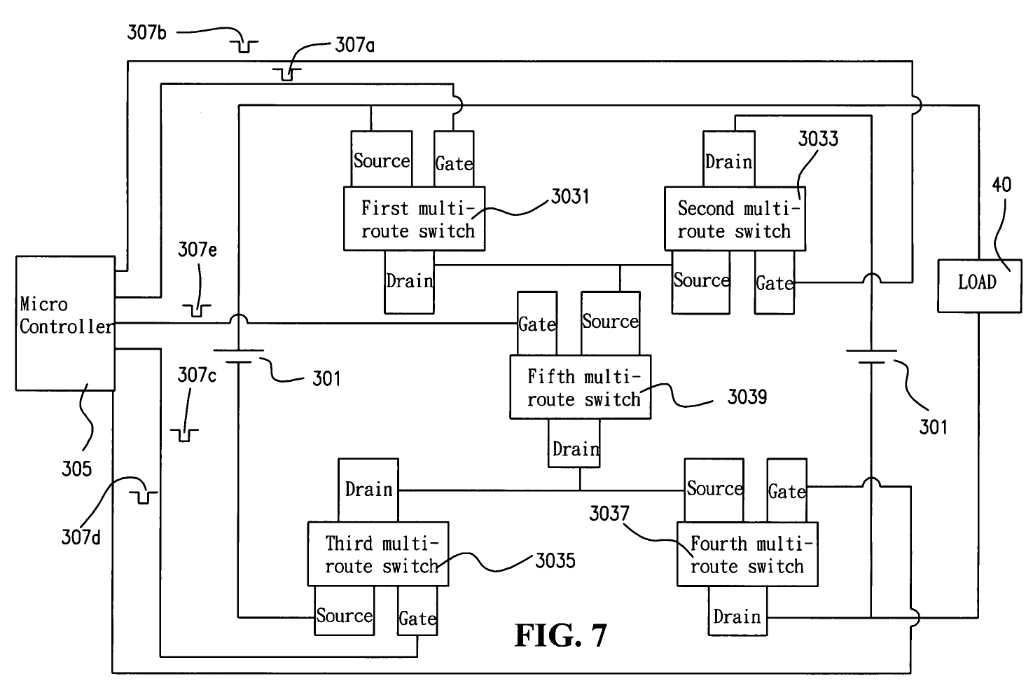

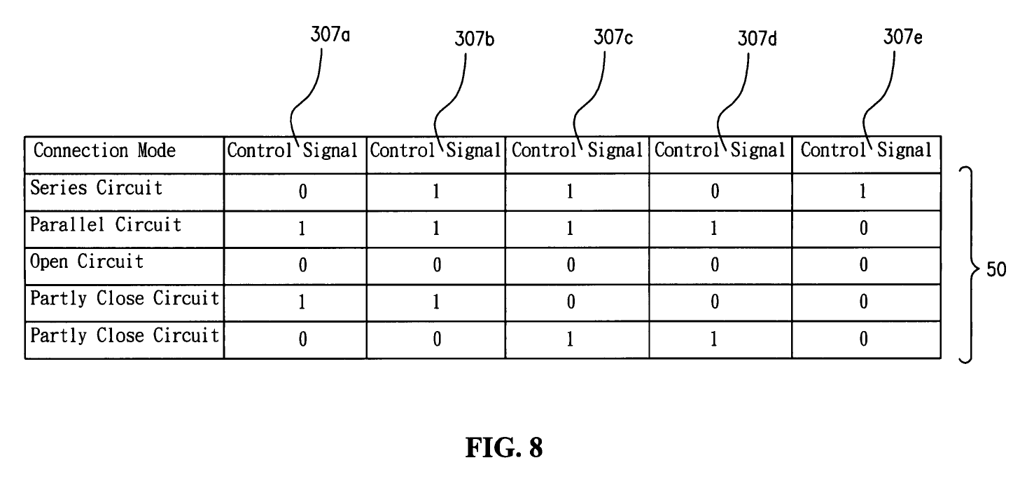

FIG. 7 illustrates the embodiment shown in FIG. 3 and FIG. 8 illustrates the multi-route switches shown in FIG. 7 being controlled to switch to one of the corresponding electrical connections. The first multi-route switch 3031 to the fifth multi-route switch 3039 shown in FIG. 7 are electronic multi-route switches such as a MOSFET electronic component. When the gates of the multi-route switches are “1” (high voltage level), the source is connected to the drain in electrical effect. Inversely, when the gates of multi-route switch 3031˜3039 are “0” (low voltage level), the source is disconnected from the drain (open circuit) in electrical effect. The micro controller 305 separately outputs control signals 307a, 307b, 307c, 307d, 307e to the first to fifth multi-route switches 3031˜3039 so as to achieve the series connection, parallel connection, open circuit and partly close connection as shown in FIG. 8.

The micro controller 305 is further capable of monitoring the power generation condition of each fuel cell 301 and to detect the health of each fuel cell 301, so that the optimal connection arrangements are made.

The fuel cells 301 can be fuel cell units, stack type fuel cells, planar type fuel cells, hybrid type fuel cells, etc. Further, the fuel cells 301 can be proton exchange membrane fuel cells (PEMFC), direct methanol fuel cells (DMFC), etc.

It is noted that the method 20 and the fuel cell system 30 according to the present invention are not limited for the preceding examples of two fuel cells 301. That is, the method 20 and the fuel cell system 30 according to the present invention can be implemented with more than two fuel cells 301. Such modification or variation still falls within the scope of this invention.

While the invention has been described with referencing to preferred embodiments thereof, it is to be understood that modifications or variations may be easily made without departing from the spirit of this invention, which is defined by the appended claims.

What is claimed is:

1. A method for arranging a fuel cell system with intelligent controllable dynamic series and parallel connections, comprising following steps:
providing at least one multi-route switch;
electrically connecting at least two fuel cells to said multi-route switch; and
controlling said multi-route switch to allow said fuel cells connecting to the multi-route switch to be in one of the connection modes, wherein said connection modes include series connection, parallel connection, open circuit and partly close circuit.

2. The method as defined in claim 1, wherein said multi-route switch is an electronic multi-route switch.

3. The method as defined in claim 1, wherein said steps of electrically connecting two or more fuel cells to said multi-route switch is to electrically connect the positive pole and negative pole of each of said two or more fuel cells to said multi-route switch respectively.

4. The method as defined in claim 1, wherein said step of controlling the multi-route switch is through a micro controller outputting a control signal to said multi-route switch to command said multi-switch to change its switches according to said control signal received.

5. The method as defined in claim 1, wherein each of said fuel cells can be one of the following fuel cell units: stack type fuel cells, planar type fuel cells, hybrid type fuel cells.

6. The method as defined in claim 1, wherein each of said fuel cells can be one of PEMFC and DMFC.

7. The method as defined in claim 4, wherein said micro controller further can monitor the state of the fuel cells.

8. A fuel cell system being intelligently arranged with controllable dynamic series and parallel connections comprising:
at least one multi-route switch;
two or more fuel cells, which are electrically connecting to said multi-route switch; and
a micro controller, which controls said multi-route switch to change the said two or more fuel cells connecting with the multi-route switch to be arranged in one of the connection modes, wherein said connection modes include series connection, parallel connection, open circuit, and partly close circuit.

9. The fuel cell system as defined in claim 8, wherein said multi-route switch is an electronic type multi-route switch.

10. The fuel cell system as defined in claim 8, wherein the positive pole and negative pole of the two or more fuel cells are connected to said multi-route switch.

11. The fuel cell system as defined in claim 8, wherein said micro controller outputs control signals to said multi-route switch to command said multi-switch to change its switches based on said control signals.

12. The fuel cell system as defined in claim 8, wherein each of said fuel cells can be one of the following fuel cell units: stack type fuel cells, planar type fuel cells, hybrid type fuel cells.

13. The fuel cell system as defined in claim 8, wherein each of said fuel cells can be one of PEMFC and DMFC.

14. The fuel cell system as defined in claim 8, wherein said micro controller further can monitor the state of the fuel cells.
